(19) United States
(12) Patent Application Publication
(10) Pub. No.: US 2010/0110947 A1
(43) Pub. Date: May 6, 2010

(54) METHOD AND APPARATUS FOR SENDING SYSTEM INFORMATION IN A WIRELESS COMMUNICATION SYSTEM

(75) Inventor: Masato Kitazoe, Tokyo (JP)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/610,706

(22) Filed: Nov. 2, 2009

Related U.S. Application Data
(60) Provisional application No. 61/110,983, filed on Nov. 3, 2008.
(60) Provisional application No. 61/160,595, filed on Mar. 16, 2009.

(51) Int. Cl. H04B 7/00

(52) U.S. Cl. 370/310

(57) ABSTRACT

Techniques for transmitting system information (SI) in SI messages to enable efficient reception by user equipments (UEs) are described. In an aspect, SI messages may be scheduled using both a forward space after a reference time and a backward space prior to the reference time to allow more SI messages to be scheduled. In one design, a base station may assign at least one SI message with at least one SI window in the forward space and may assign at least one additional SI message with at least one additional SI window in the backward space. The base station may determine the position of each SI window based on an index of the SI message, a periodicity of the SI message, and an SI window length common for all SI messages. The base station may send each SI message within the periodically occurring SI window for that SI message.

The present application claims priority to provisional U.S. Application Ser. No. 61/110,983, filed Nov. 3, 2008, and provisional U.S. Application Ser. No. 61/160,595, filed Mar. 16, 2009, both entitled “A METHOD AND APPARATUS FOR INCREASING SYSTEM INFORMATION (SI) WINDOW IN A WIRELESS COMMUNICATION SYSTEM,” assigned to the assignee hereof and incorporated herein by reference.

### BACKGROUND

I. Field

The present disclosure relates generally to communication, and more specifically to techniques for sending system information in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of base stations that can support communication for a number of user equipments (UEs). A base station may transmit system information comprising various parameters used to support operation by UEs in the system. It may be desirable to transmit the system information such that the UEs can efficiently receive the system information applicable to the UEs.

### SUMMARY

Techniques for transmitting system information in a manner to enable efficient reception by UEs are described herein. The system information may be sent in a set of system information (SI) messages. Each SI message may be transmitted within a periodically occurring time window (which may be referred to as an SI window) for the SI message. To enable efficient reception, the position of the SI window for each SI message may be defined based on an index of the SI message, a periodicity of the SI message, and an SI window length common for all SI messages, as described below.

In an aspect, SI messages may be scheduled by using both a forward space after a reference time and a backward space prior to the reference time. The reference time may be the start of a first radio frame in which all SI messages repeat. The use of both the forward and backward spaces may allow more SI messages to be transmitted.

In one design, a base station may assign at least one SI message with at least one SI window in the forward space and may assign at least one additional SI message with at least one additional SI window in the backward space. In one scheduling design, the base station may determine a list of SI messages to send and may alternately assign the SI messages in the list to the forward and backward spaces. In particular, the base station may assign every other SI message in the list with an SI window in the forward space and may assign each remaining SI message in the list with an SI window in the backward space. In another scheduling design, the base station may elect to send certain SI messages in the forward space and to send other SI messages in the backward space. The base station may determine the position of the at least one SI window in the forward space based on a first set of equations and may determine the position of the at least one additional SI window in the backward space based on a second set of equations. For all scheduling designs, the base station may send each SI message within the SI window for that SI message.

In one design, a UE may identify at least one SI message assigned at least one SI window in the forward space and may also identify at least one additional SI message assigned at least one additional SI window in the backward space. The UE may receive each SI message within the SI window for that SI message.

Various aspects and features of the disclosure are described in further detail below.

### BRIEF DESCRIPTION OF THE DRAWINGS

FIG. 1 shows a wireless communication system.

FIG. 2 shows an exemplary frame structure.

FIG. 3 shows transmission of SI messages using only forward space.

FIGS. 4 and 5 show two designs for transmitting SI messages using both forward and backward spaces.

FIG. 6 shows a process for sending system information.

FIG. 7 shows an apparatus for sending system information.

FIG. 8 shows a process for receiving system information.

FIG. 9 shows an apparatus for receiving system information.

FIG. 10 shows a process for exchanging system information.

FIG. 11 shows an apparatus for exchanging system information.

FIG. 12 shows a block diagram of a base station and a UE.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the systems and radio technologies mentioned above as well as other systems and radio technologies. For clarity, certain aspects of the techniques are described below for LTE, and LTE terminology is used in much of the description below.

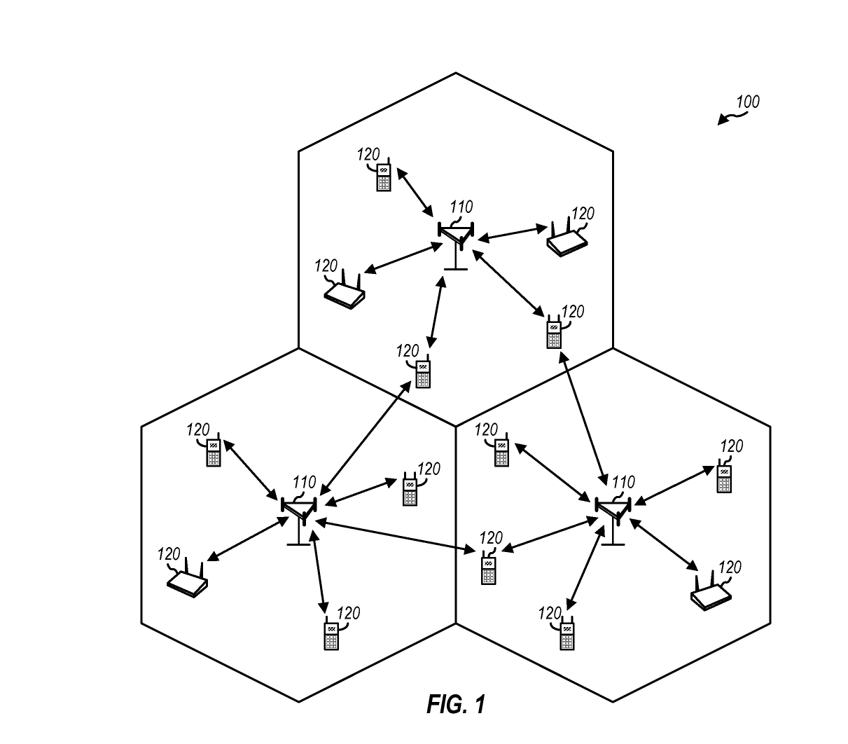

FIG. 1 shows a wireless communication system 100, which may be an LTE system or some other system. System 100 may include a number of evolved Node Bs (eNBs) 110 and other network entities. An eNB may be a station that communicates with the UEs and may also be referred to as a base station, a Node B, an access point, etc. UEs 120 may be dispersed throughout the system, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may communicate with an eNB via the downlink and uplink. The downlink (or forward link) refers to the communication link from the eNB to the UE, and the uplink (or reverse link) refers to the communication link from the UE to the eNB.

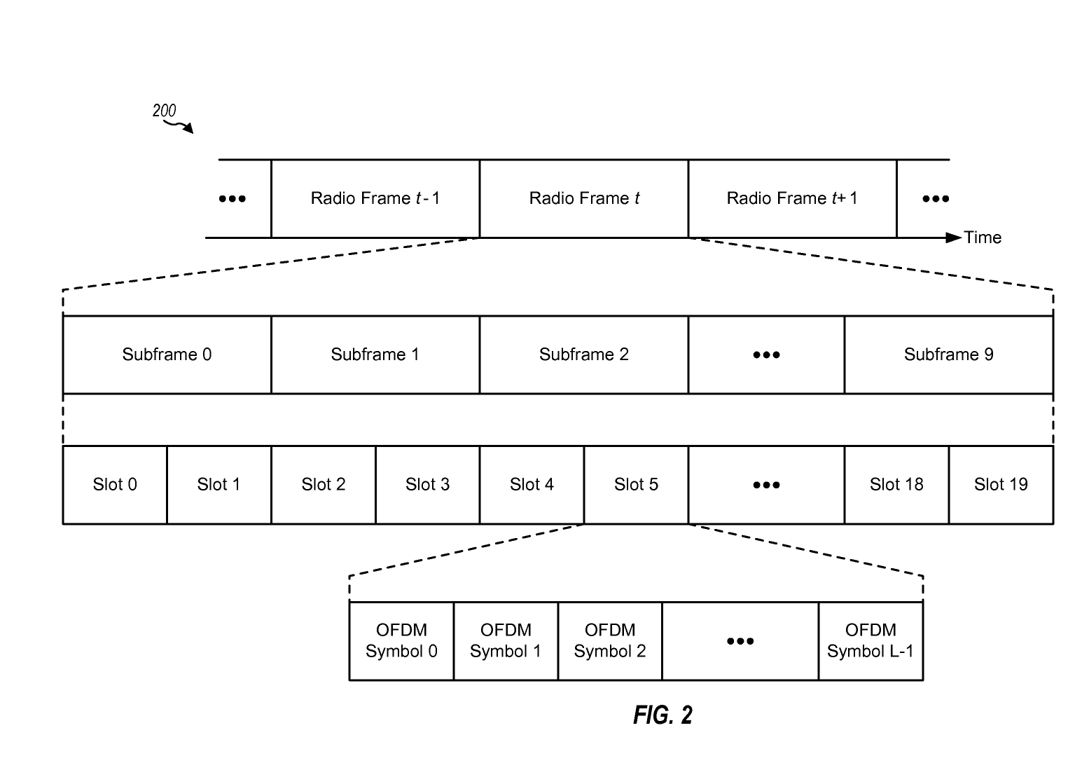

FIG. 2 shows a frame structure 200 used in LTE. The transmission timeline for the downlink may be partitioned into units of radio frames. Each radio frame may have a predetermined duration (e.g., 10 milliseconds (ms)) and may be assigned a 10-bit system frame number (SFN). The SFN may be reset to 0 at a specific time, increment by one for each radio frame thereafter, and wrap around to zero after reaching the maximum value of 1023. Each radio frame may be partitioned into 10 subframes with indices of 0 through 9, and each subframe may include two slots. Each radio frame may thus include 20 slots with indices of 0 to 19. Each slot may include L symbol periods, where L may be equal to 6 for an extended cyclic prefix or 7 for a normal cyclic prefix. An orthogonal frequency division multiplex (OFDM) symbol may be transmitted in each symbol period on the downlink.

Each eNB may transmit system information to convey various parameters used to support operation by UEs. The system information may be partitioned into a master information block (MIB) and a number of system information blocks (SIBs) to enable efficient transmission and reception of the system information. The MIB may include a limited number of essential parameters used to acquire other information from the eNB. The MIB may be transmitted periodically on a Broadcast Channel (BCH) with a fixed schedule of 40 ms in subframe 0 of each radio frame for which (SFN mod 4)=0, where “mod” denotes a modulo operation.

K SIBs may be defined and may be referred to as system information block types 1 through K, or SIB1 through SIBK. In general, K may be any integer value, e.g., K=11 for LTE Release 8. Each SIB may carry a specific set of parameters to support operation by UEs. SIB1 may carry scheduling information for N SI messages as well as a mapping of SIBs to SI messages, where N may be one or greater. The scheduling information may include (i) a scheduling list containing the N SI messages being transmitted, (ii) an SI window length indicating the time duration in which an SI message might be sent, and (iii) the periodicity of each SI message. The mapping may indicate which SIBs are sent in each SI message, with each SIB being sent in only one SI message. SIB1 and SI messages may be transmitted on a Downlink Shared Channel (DL-SCH). SIB1 may be transmitted with a periodicity of 80 ms in subframe 5 of each radio frame for which (SFN mod 8)=0.

The SI messages may be transmitted within periodically occurring time domain windows, which may be referred to as SI windows. Each SI message may be associated with a specific SI window, which may occur at the periodicity of the SI message. The SI windows for different SI messages do not overlap in time. Thus, for any given SI window, only the corresponding SI message may be transmitted within that SI window. Each SI message may be transmitted one or more times within its SI window with dynamic scheduling. For each transmission of an SI message, control information may be sent on a Physical Downlink Control Channel (PDCCH) within the SI window for the SI message, and data for the SI message may be sent on a Physical Downlink Shared Channel (PDSCH) as indicated by the control information.

The SI windows for the SI messages may be defined to have the following characteristics:
The position of an SI window for an SI message can be determined based on an index n for the SI message, the periodicity of the SI message (i.e., the SI repetition cycle), and the SI window size common for all SI messages, and
A single SI window size is used for all SI messages, and
The SI windows for all SI messages do not overlap in time.

The characteristics described above may reduce implementation complexity at the UEs. These characteristics may also enable targeted reception of a particular SI message by a UE. In particular, the UE can determine the position of the SI window for the particular SI message based solely on scheduling information (the index n and periodicity) for the SI message, without having to know scheduling information for the other SI messages.

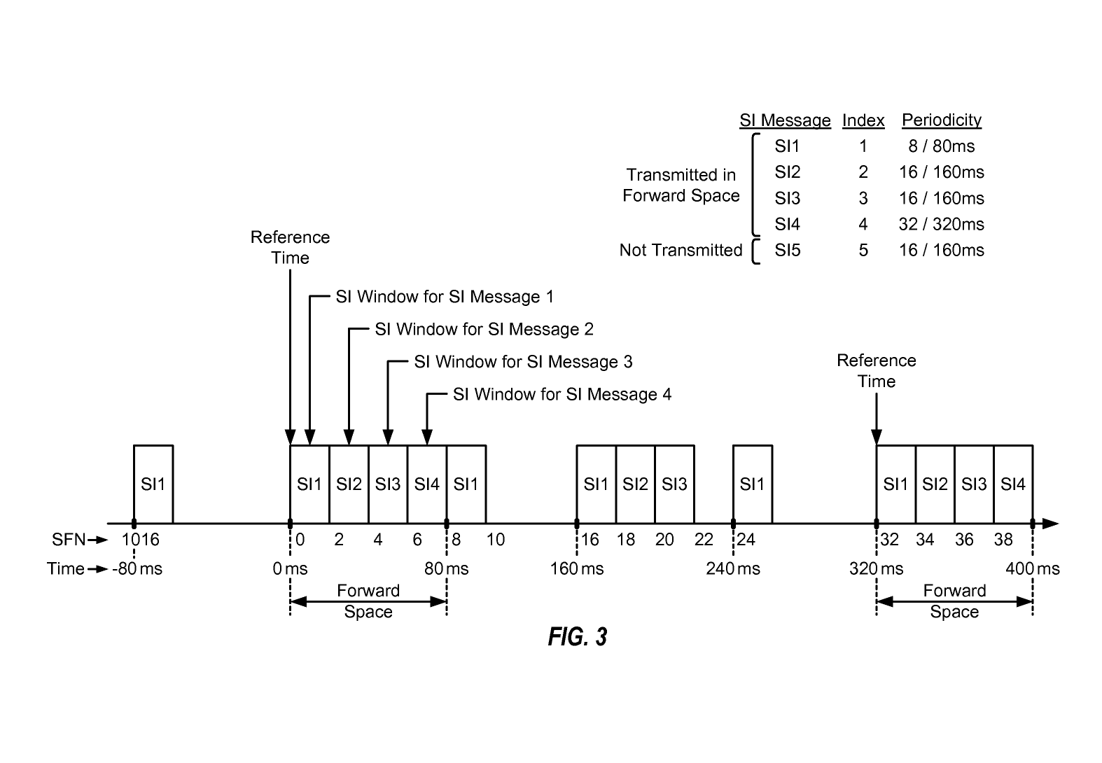

FIG. 3 shows exemplary transmission of SI messages using only the forward space. In the example shown in FIG. 3, five SI messages may be scheduled with the parameters given in Table 1. Index n for each SI message is determined by the position of that SI message in the list of SI messages to be transmitted, so that an SI message with index n is the n-th SI message in the list. The periodicity of each SI message is configurable and can be given in units of ms or in number of radio frames (T). The SI window length is common for all SI messages and is configurable. The SI window length may be selected from a set of possible lengths, which may include 1, 2, 5, 10, 15, and 40 ms.

TABLE 1

| | | SI Periodicity | SI Periodicity | SI Window |
|---|---|---|---|---|
| SI Message | Index n | Tₙ | ms | Length ms |
| SI1 | 1 | 8 | 80 | 20 |
| SI2 | 2 | 16 | 160 | 20 |
| SI3 | 3 | 16 | 160 | 20 |
| SI4 | 4 | 32 | 320 | 20 |
| SI5 | 5 | 16 | 160 | 20 |

The position of the SI window for each SI message may be determined as follows:

SFN mod Tₙ=FLOOR(xₙ/10), and Eq (1)

xₙ=(n−1)*w, Eq (2)

where
Tₙ is the periodicity of SI message n (SIn), for 1≦n≦N,
xₙ is an SI window offset for SI message n (in units of ms),
w is the SI window length, and
FLOOR denotes a floor operation that provides the largest integer less than or equal to the argument.

For the example shown in Table 1, SI message 1 (SI1) has an index of 1, a periodicity of 80 ms, and an SI window offset of 0 ms. SI1 may be transmitted in an SI window that starts in every 8 radio frames in which (SFN mod 8)=0, or radio frames 0, 8, 16, 24, 32, etc. SI message 2 (SI2) has an index of 2, a periodicity of 160 ms, and an SI window offset of 20 ms. SI2 may be transmitted in an SI window that starts in every 16 radio frames in which (SFN mod 16)=2, or radio frames 2, 18, 34, etc. SI message 3 (SI3) has an index of 3, a periodicity of 160 ms, and an SI window offset of 40 ms. SI3 may be transmitted in an SI window that starts in every 16 radio frames in which (SFN mod 16)=4, or radio frames 4, 20, 36, etc. SI message 4 (SI4) has an index of 4, a periodicity of 320 ms, and an SI window offset of 60 ms. SI4 may be transmitted in an SI window that starts in every 32 radio frames in which (SFN mod 32)=6, or radio frames 6, 38, etc.

SI message 5 (SI5) has an index of 5, a periodicity of 160 ms, and an SI window offset of 80 ms. SI5 should be transmitted in an SI window that starts in every 16 radio frames in which (SFN mod 16)=8, or radio frames 8, 24, etc. However, the SI window for SI5 would overlap with the SI window for SI1 in radio frames 8, 24, etc., which would then violate the third characteristic described above. SI5 cannot be scheduled if the characteristics described above are to be retained.

For the scheduling design using equations (1) and (2), progressively later SI messages in the scheduling list are assigned progressively larger SI window offsets. The SI windows for progressively later SI messages are then placed progressively further to the right of a reference time. The reference time may be defined as the start of a radio frame in which (SFN mod Tₙ)=0 for all indices n, which may be the start of the first radio frame in which all SI messages repeat.

A forward space may be defined as the time duration from the reference time to the start of the next radio frame for the SI window for the SI message with the shortest periodicity. In the example shown in FIG. 3, the forward space is from 0 to 80 ms, which corresponds to the shortest SI periodicity of 80 ms.

For the scheduling design using equations (1) and (2), SI windows may be placed only in the forward space since the SI window offsets increase for progressively larger index n. The forward space is restricted by the SI message with the shortest periodicity, which is 80 ms for the example shown in FIG. 3. The number of SI messages that may be scheduled may be given as:

$$Max number of SI messages ( {N}_{ma x} ) = \frac{Shortest SI Periodicity}{SI Window Length} . \qquad Eq ( 3 )$$

In the example shown in FIG. 3, four SI messages may be scheduled since the shortest SI periodicity is 80 ms and the SI window length is 20 ms. As a result, the fifth SI message (SI5) cannot be scheduled.

As shown in equation (3), SI window allocation in the time domain may be dimension limited. More SI messages may be scheduled by increasing the shortest SI periodicity and/or by reducing the SI window length. However, increasing the shortest SI periodicity would extend the amount of time needed to receive the SI message, which may be undesirable. Reducing the SI window length may result in concentrated resource usage for transmissions of SI messages, which may also be undesirable.

In an aspect, SI messages may be scheduled by using both the forward space after the reference time and the backward space prior to the reference time. This may allow more SI messages to be scheduled while retaining the desired characteristics described above. SI messages may be scheduled using both the forward and backward spaces in various manners.

In a first scheduling design, the N SI messages in a scheduling list may be alternately scheduled in the forward space and the backward space. For this design, the position of the SI window for each SI message may be determined as follows:

$$\begin{matrix}SFN mod {T}_{n} = ( {T}_{n} + FLOOR ( {x}_{n} / 10 ) ) mod {T}_{n} , \\ and & Eq ( 4 ) \\ {x}_{n} = - {1}^{( ( n - 1 ) mod 2 )} * CEIL ( \frac{n - 1}{2} ) * w , & Eq ( 5 )\end{matrix}$$

where CEIL denotes a ceiling operation that provides the smallest integer greater than or equal to the argument.

In the design shown in equation (5), SI messages with odd indices (e.g., n=1, 3, 5, etc.) have positive SI window offsets, and SI messages with even indices (e.g., n=2, 4, 6, etc.) have negative SI window offsets due to the −1^{((n-1) mod 2)} term. The −1^{((n-1) mod 2)} term may also be replaced with 2*(n mod 2)−1 or some other equivalent function. SI messages with progressively higher indices have progressively larger SI window offset from the reference time due to the CEIL term. Equation (4) is a modified version of equation (1) to account for both positive and negative SI window offsets.

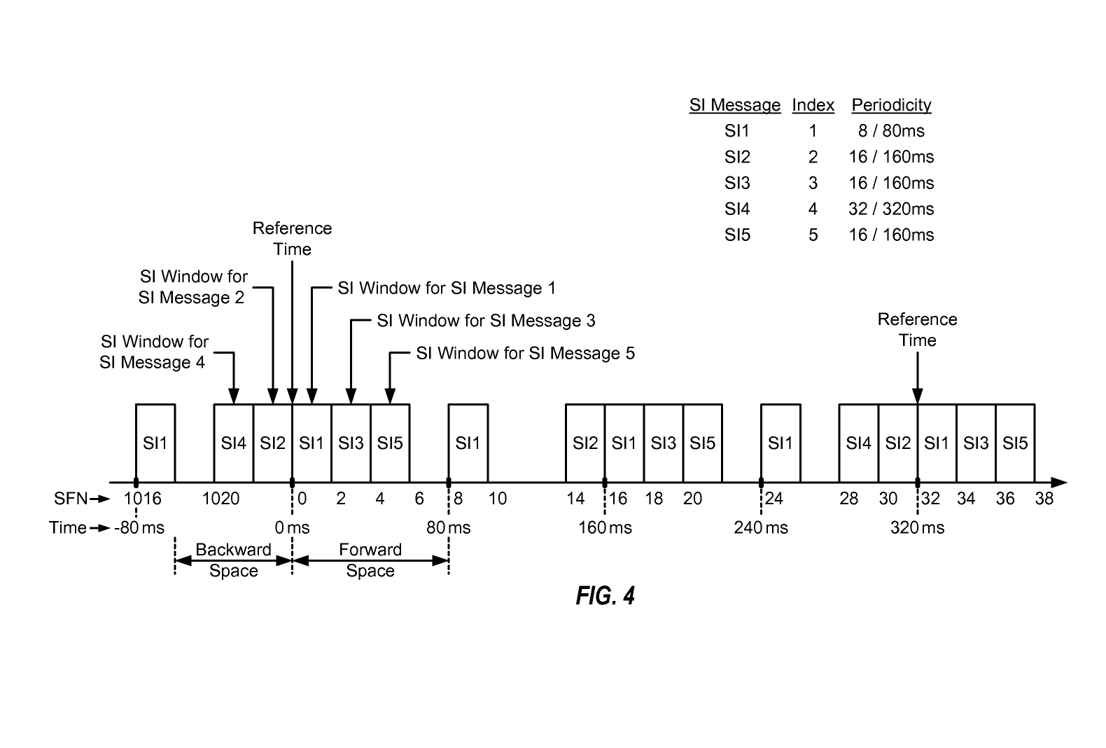

FIG. 4 shows exemplary transmission of SI messages using both the forward and backward spaces in accordance with the first scheduling design. In the example shown in FIG. 4, five SI messages SI1 through SI5 are scheduled with the parameters given in Table 1. SI message 1 has an SI window offset of 0 ms and may be transmitted in an SI window that starts in every 8 radio frames in which (SFN mod 8)=0, or radio frames 0, 8, 16, 24, 32, . . . , 1016. SI message 2 has an SI window offset of −20 ms and may be transmitted in an SI window that starts in every 16 radio frames in which (SFN mod 16)=14, or radio frames 14, 30, . . . , 1022. SI message 3 has an SI window offset of 20 ms and may be transmitted in an SI window that starts in every 16 radio frames in which (SFN mod 16)=2, or radio frames 2, 18, 34, . . . , 1010. SI message 4 has an SI window offset of −40 ms and may be transmitted in an SI window that starts in every 32 radio frames in which (SFN mod 32)=28, or radio frames 28, 60, . . . , 1020. SI message 5 has an SI window offset of 40 ms and may be transmitted in an SI window that starts in every 16 radio frames in which (SFN mod 16)=4, or radio frames 4, 20, 36, . . . , 1012.

For the first scheduling design using equations (4) and (5), SI messages with odd indices have positive SI window offsets and are mapped to the forward space. SI messages with even indices have negative SI window offsets and are mapped to the backward space. Furthermore, progressively later SI messages in the scheduling list are assigned progressively larger SI window offsets. The SI windows for progressively later SI messages are then placed progressively further away from the reference time.

As shown in FIG. 4, the backward space may be defined as the time duration from the reference time to the end of the radio frame for the SI window for the SI message with the shortest periodicity. In the example shown in FIG. 4, the forward space is from 0 to 80 ms, and the backward space is from 0 to −60 ms. Up to three more SI messages may be scheduled in the backward space for the design shown in FIG. 4 in comparison to the design shown in FIG. 3.

In the first scheduling design, SI windows may be allocated to SI messages by switching back and forth between the forward space and the backward space. A single set of equations (4) and (5) may be used to determine the position of the SI window for each SI message based on index n and the periodicity of that SI message. The first scheduling design can achieve the desired characteristics described above.

In a second scheduling design, the SI messages may be scheduled in the forward and backward spaces using different indices for the forward and backward spaces. N SI messages may be scheduled in the forward space and may be assigned indices n=1, . . . , N, where N may be any integer value equal to or less than Nₘₐₓ given in equation (3). The position of the SI window in the forward space for each SI message with index n may be determined as shown in equations (1) and (2).

M SI messages may be scheduled in the backward space and may be assigned indices m=1, . . . , M, where M may be any integer value equal to or less than Mₘₐₓ, which is the maximum number of SI messages supported in the backward space. The position of the SI window in the backward space for each SI message with index m may be determined as follows:

SFN mod Tₘ=(Tₘ+FLOOR(xₘ/10))mod Tₘ, and Eq (6)

Xₘ=−M*w, Eq (7)

where
Tₘ is the periodicity of the SI message with index m, for 1≦m≦M, and
xₘ is an SI window offset for SI message m (in units of ms).

In the design shown in equation (7), SI messages with progressively larger index m have progressively larger SI window offsets in the negative direction. The SI windows for SI messages with progressively larger index m are then progressively further from the reference time in the negative direction.

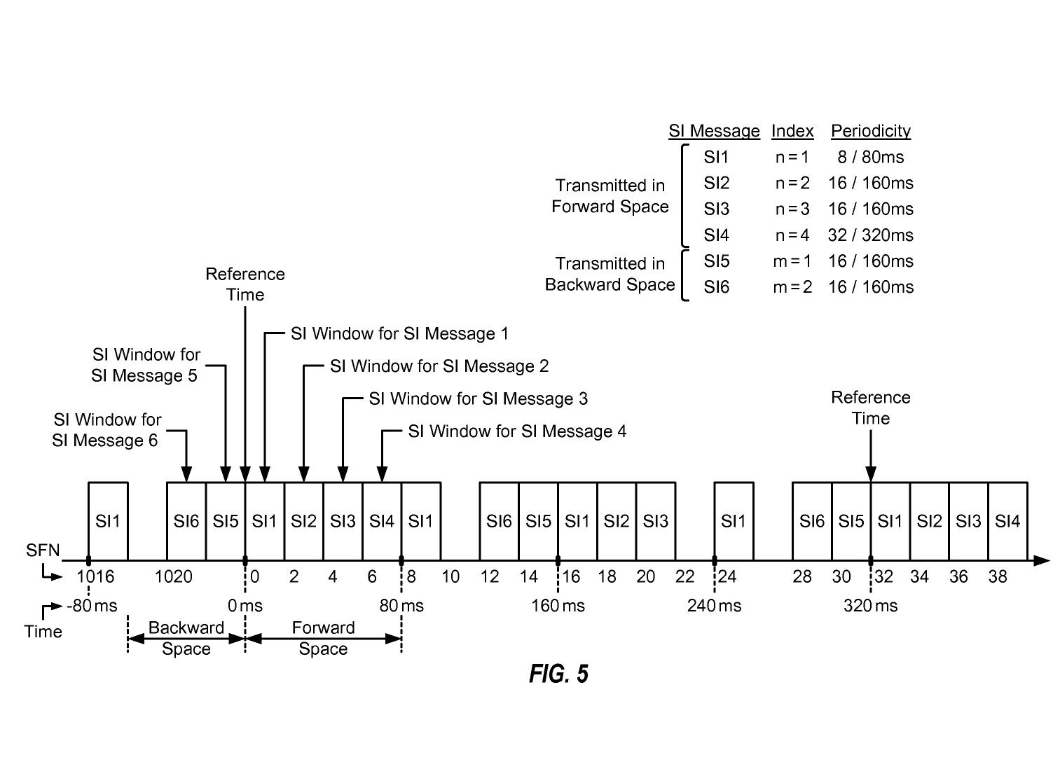

FIG. 5 shows exemplary transmission of SI messages using both the forward and backward spaces in accordance with the second scheduling design. In the example shown in FIG. 5, six SI messages SI1 through SI6 are scheduled. The first five SI messages SI1 through SI5 are scheduled with the parameters given in Table 1. The sixth SI message SI6 is scheduled with the same parameters as SI5.

SI messages SI1 through SI4 are assigned indices of n=1 through 4, respectively, and are scheduled in the forward space. SB1 has an SI window offset of 0 ms and may be transmitted in an SI window that starts in every 8 radio frames in which (SFN mod 8)=0, or radio frames 0, 8, 16, 24, 32, . . . , 1016. SB2 has an SI window offset of 20 ms and may be transmitted in an SI window that starts in every 16 radio frames in which (SFN mod 16)=2, or radio frames 2, 18, 34, . . . , 1010. SB3 has an SI window offset of 40 ms and may be transmitted in an SI window that starts in every 16 radio frames in which (SFN mod 16)=4, or radio frames 4, 20, 36, . . . , 1012. SI4 has an SI window offset of 60 ms and may be transmitted in an SI window that starts in every 32 radio frames in which (SFN mod 32)=6, or radio frames 6, 38, . . . , 998.

SI messages SI5 and SI6 are assigned indices of m=1 and 2, respectively, and are scheduled in the backward space. SI5 has an SI window offset of −20 ms and may be transmitted in an SI window that starts in every 16 radio frames in which (SFN mod 16)=14, or radio frames 14, 30, . . . , 1022. SI6 has an SI window offset of −40 ms and may be transmitted in an SI window that starts in every 16 radio frames in which (SFN mod 16)=12, or radio frames 12, 28, . . . , 1020.

For the second scheduling design, N SI messages with indices n=1, . . . , N may be scheduled in the same manner as shown in FIG. 3 using equations (1) and (2). These N SI messages can be received by “legacy” UEs that support reception of SI messages in only the forward space. The legacy UEs may be UEs that support LTE Release 8. The second scheduling design may thus be backward compatible with the scheduling design shown in FIG. 3 using equations (1) and (2).

For the second scheduling design, M SI messages with indices m=1, . . . , M may be scheduled in the backward space with equations (6) and (7). These M SI messages can be received by “new” UEs that support reception of SI messages in both the forward and backward spaces. The new UEs may be UEs that support LTE Release 9 or later, UEs that support LTE Release 8 and functionalities to receive SI messages in the backward space, etc. These M SI messages may carry “new” SIBs, which may be SIBs that can be sent in the backward space and received by new UEs, SIBs defined in Release 9 or later, etc.

Indices n and m for SI messages may be conveyed to UEs in various manners. In one design, the indices may be implicitly conveyed. For example, the first N. SI messages in a scheduling list may be assigned indices n=1, . . . , Nₘₐₓ, and subsequent SI messages in the scheduling list may be assigned indices m=1, . . . , M. In another design, the indices may be explicitly conveyed. For example, one scheduling list may include N SI messages with indices n=1, . . . , N, and another scheduling list may include M SI messages with indices m=1, . . . , M. SIB1 may include separate scheduling information containers (e.g., separate scheduling lists) for SI messages with indices n and m. As another example, the scheduling list may include an additional bit for each SI message. This bit may be set to a first value (e.g., ‘1 ’) to indicate index n or to a second value (e.g., ‘0 ’) to indicate index m. For both designs, the position of SI windows may be calculated in different manners (e.g., using different equations) for SI messages with indices n and m.

The first and second scheduling designs are two exemplary schemes for scheduling SI messages in both the forward and backward spaces. The scheduling may be performed in other manners. In general, SI messages may be scheduled in the forward and backward spaces using any mapping scheme, with two exemplary schemes being shown in FIGS. 4 and 5. The SI windows for the SI messages may also be defined using one or more sets of equations, e.g., using one set of equations in FIG. 4 or two sets of equations in FIG. 5.

The techniques described herein for scheduling SI messages in both the forward and backward spaces may provide certain advantages. First, the techniques may support scheduling of more SI messages. This may be desirable for LTE Release 9 and later, since newly introduced features may require additional SIBs, which may need to be sent in more SI messages. Second, the techniques can retain the desired characteristics described above, which may simplify UE implementation and enable efficient reception of system information.

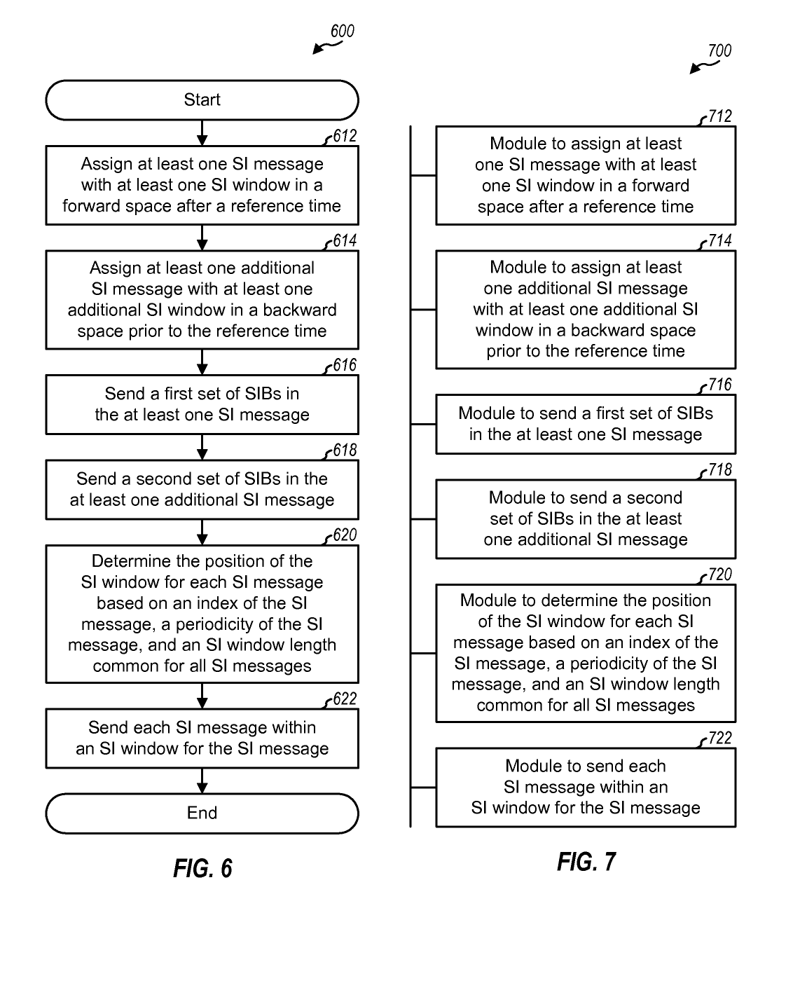

FIG. 6 shows a design of a process 600 for sending system information in a wireless communication system. Process 600 may be performed by a base station/eNB (as described below) or by some other entity. The eNB may assign at least one SI message with at least one SI window in a forward space after a reference time (block 612). The eNB may assign at least one additional SI message with at least one additional SI window in a backward space prior to the reference time (block 614). The reference time may be the start of a radio frame in which all SI messages repeat, e.g., as shown in FIGS. 4 and 5.

The eNB may send a first set of SIBs in the at least one SI message (block 616) and may send a second set of SIBs in the at least one additional SI message (block 618). In one design, the first and second sets of SIBs may be receivable by all UEs. In another design, the first set of SIBs may be receivable by all UEs, and the second set of SIBs may be receivable by UEs capable of receiving SI messages in both the forward and backward spaces. The eNB may determine the position of the SI window for each SI message based on an index of the SI message, a periodicity of the SI message, and an SI window length common for all SI messages (block 620). The eNB may send each SI message within the SI window for that SI message (block 622).

In one scheduling design, which is shown in FIG. 4, the eNB may determine a list of SI messages to send. The eNB may assign every other SI message in the list with an SI window in the forward space and may assign each remaining SI message in the list with an SI window in the backward space. The eNB may determine the position of the SI window for each SI message as shown in equations (4) and (5) or based on some other set of equations.

In another scheduling design, which is shown in FIG. 5, the eNB may elect to send certain SI messages in the forward space and other SI messages in the backward space. In one design, the eNB may explicitly indicate whether each SI message is sent in the forward or backward space, e.g., using different lists of SI messages for the forward and backward spaces, using a bit for each SI message to indicate the forward or backward space, etc. In another design, the eNB may implicitly indicate whether each SI message is sent in the forward or backward space. For example, the eNB may determine a list of SI messages to send. The list may include the at least one SI message in the forward space followed by the at least one additional SI message in the backward space. For both the explicit and implicit cases, the eNB may assign the at least one SI message with a first index n for the forward space and may assign the at least one additional SI message with a second index m for the backward space. The eNB may determine the position of the at least one SI window in the forward space based on a first set of equations, e.g., equations (1) and (2). The eNB may determine the position of the at least one additional SI window in the backward space based on a second set of equations, e.g., equations (6) and (7).

FIG. 7 shows a design of an apparatus 700 for sending system information in a wireless communication system. Apparatus 700 includes a module 712 to assign at least one SI message with at least one SI window in a forward space after a reference time, a module 714 to assign at least one additional SI message with at least one additional SI window in a backward space prior to the reference time, a module 716 to send a first set of SIBs in the at least one SI message, a module 718 to send a second set of SIBs in the at least one additional SI message, a module 720 to determine the position of the SI window for each SI message based on an index of the SI message, a periodicity of the SI message, and an SI window length common for all SI messages, and a module 722 to send each SI message within an SI window for the SI message.

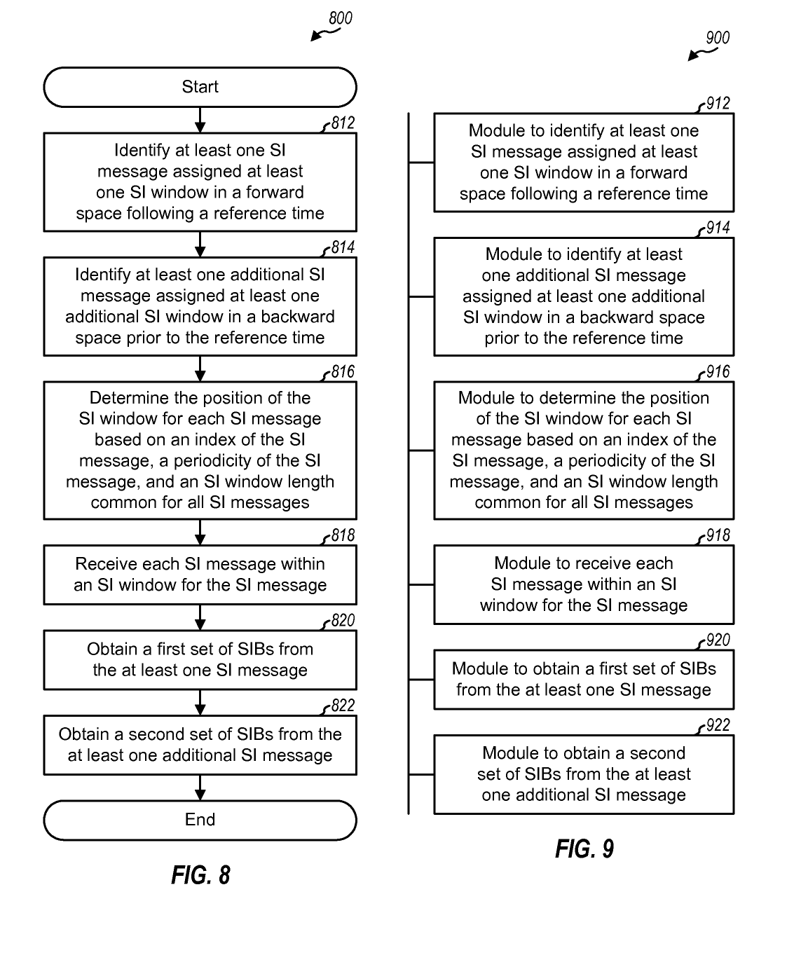

FIG. 8 shows a design of a process 800 for receiving system information in a wireless communication system. Process 800 may be performed by a UE (as described below) or by some other entity. The UE may identify at least one SI message assigned at least one SI window in a forward space following a reference time (block 812). The UE may also identify at least one additional SI message assigned at least one additional SI window in a backward space prior to the reference time (block 814). The UE may determine the position of the SI window for each SI message based on an index of the SI message, a periodicity of the SI message, and an SI window length common for all SI messages (block 816). The UE may then receive each SI message within the SI window for that SI message (block 818). The UE may obtain a first set of SIBs from the at least one SI message (block 820) and may obtain a second set of SIBs from the at least one additional SI message (block 822). In one design, the first and second sets of SIBs may be intended for all UEs. In another design, the first set of SIBs may be intended for all UEs, and the second set of SIBs may be intended for UEs capable of receiving SI messages in both the forward and backward spaces.

In one scheduling design, the UE may receive a list of SI messages being sent. Every other SI message in the list may be assigned an SI window in the forward space, and each remaining SI message in the list may be assigned an SI window in the backward space. In another scheduling design, the UE may receive an explicit or implicit indication of whether each SI message is sent in the forward or backward space. For both scheduling designs, the UE may determine the position of the SI windows for all SI messages based on a single set of equations, e.g., equations (4) and (5). Alternatively, the UE may determine the position of the at least one SI window in the forward space based on a first set of equations, e.g., equations (1) and (2), and may determine the position of the at least one additional SI window in the backward space based on a second set of equations, e.g., equations (6) and (7).

FIG. 9 shows a design of an apparatus 900 for receiving system information in a wireless communication system. Apparatus 900 includes a module 912 to identify at least one SI message assigned at least one SI window in a forward space following a reference time, a module 914 to identify at least one additional SI message assigned at least one additional SI window in a backward space prior to the reference time, a module 916 to determine the position of the SI window for each SI message based on an index of the SI message, a periodicity of the SI message, and an SI window length common for all SI messages, a module 918 to receive each SI message within an SI window for the SI message, a module 920 to obtain a first set of SIBs from the at least one SI message, and a module 922 to obtain a second set of SIBs from the at least one additional SI message.

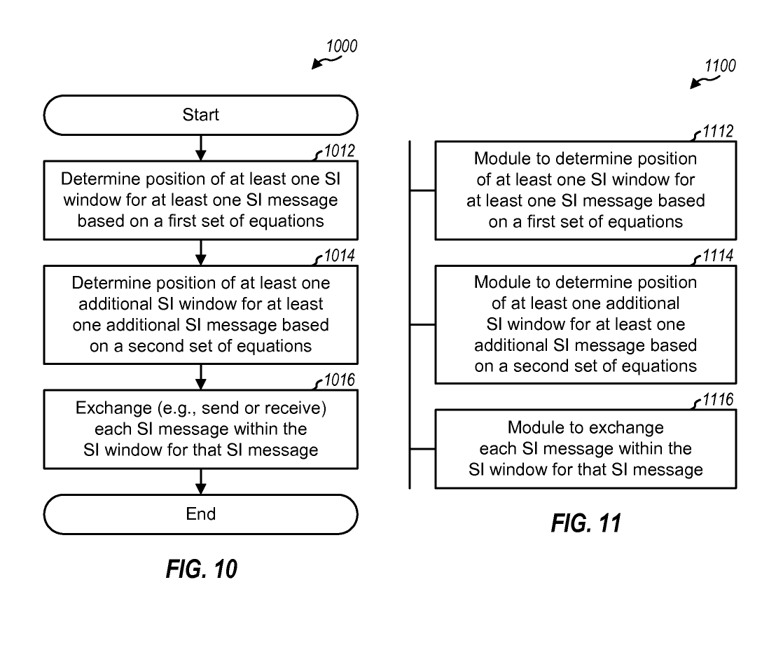

FIG. 10 shows a design of a process 1000 for exchanging system information. The position of at least one SI window for at least one SI message may be determined based on a first set of equations (block 1012). The position of at least one additional SI window for at least one additional SI message may be determined based on a second set of equations (block 1014). The position of the SI window for each SI message may be determined based on an index of the SI message, a periodicity of the SI message, and an SI window length common for all SI messages. In general, the SI window for each SI message may be located anywhere. In one design, the at least one SI window may be located in a forward space following a reference time, and the at least one additional SI window may be located in a backward space prior to the reference time.

Each SI message may be exchanged (e.g., sent or received) within the SI window for that SI message (block 1016). In one design, process 1000 may be performed by a base station/eNB, which may send each SI message within the SI window for that SI message. In another design, process 1000 may be performed by a UE, which may receive each SI message within the SI window for that SI message.

FIG. 11 shows a design of an apparatus 1100 for exchanging system information. Apparatus 1100 includes a module 1112 to determine the position of at least one SI window for at least one SI message based on a first set of equations, a module 1114 to determine the position of at least one additional SI window for at least one additional SI message based on a second set of equations, and a module 1116 to exchange each SI message within the SI window for that SI message.

The modules in FIGS. 7, 9 and 11 may comprise processors, electronics devices, hardware devices, electronics components, logical circuits, memories, software codes, firmware codes, etc., or any combination thereof.

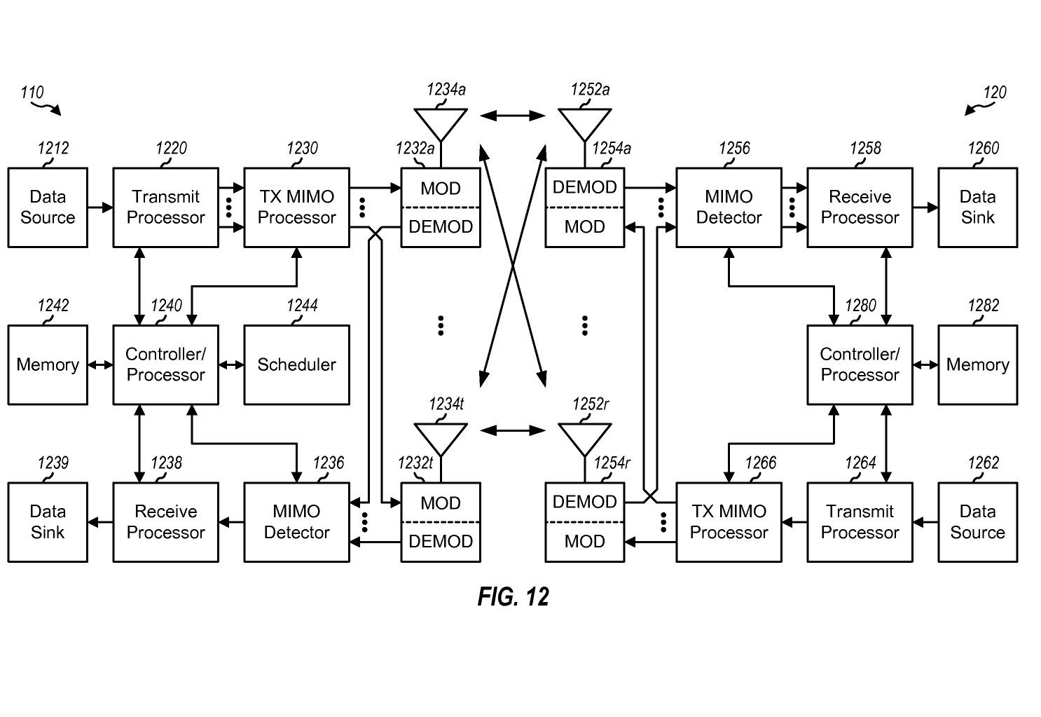

FIG. 12 shows a block diagram of a design of a base station/eNB 110 and a UE 120, which may be one of the eNBs and one of the UEs in FIG. 1. In this design, eNB 110 is equipped with T antennas 1234a through 1234t, and UE 120 is equipped with R antennas 1252a through 1252r, where in general T≧1 and R≧1.

At eNB 110, a transmit processor 1220 may receive data for one or more UEs from a data source 1212, process (e.g., encode, interleave, and modulate) the data for each UE based on one or more transport formats selected for that UE, and provide data symbols for all UEs. Transmit processor 1220 may also process system information (e.g., MIB, SIBs, SI messages, etc.) and control information from a controller/processor 1240 and provide overhead symbols. A transmit (TX) multiple-input multiple-output (MIMO) processor 1230 may multiplex the data symbols, the overhead symbols, and/or reference symbols. TX MIMO processor 1230 may perform spatial processing (e.g., precoding) on the multiplexed symbols, if applicable, and may provide T output symbol streams to T modulators (MODs) 1232a through 1232t. Each modulator 1232 may process a respective output symbol stream (e.g., for OFDM) to obtain an output sample stream. Each modulator 1232 may further process (e.g., convert to analog, amplify, filter, and upconvert) the output sample stream to obtain a downlink signal. T downlink signals from modulators 1232a through 1232t may be transmitted via T antennas 1234a through 1234t, respectively.

At UE 120, antennas 1252a through 1252r may receive the downlink signals from eNB 110 and provide received signals to demodulators (DEMODs) 1254a through 1254r, respectively. Each demodulator 1254 may condition (e.g., filter, amplify, downconvert, and digitize) a respective received signal to obtain received samples. Each demodulator 1254 may further process the received samples (e.g., for OFDM) to obtain received symbols. A MIMO detector 1256 may obtain received symbols from all R demodulators 1254a through 1254r, perform MIMO detection on the received symbols if applicable, and provide detected symbols. A receive processor 1258 may process (e.g., demodulate, deinterleave, and decode) the detected symbols, provide decoded data for UE 120 to a data sink 1260, and provide decoded system and control information to a controller/processor 1280.

On the uplink, at UE 120, data from a data source 1262 and control information from controller/processor 1280 may be processed by a transmit processor 1264, precoded by a TX MIMO processor 1266 if applicable, conditioned by modulators 1254a through 1254r, and transmitted to eNB 110. At eNB 110, the uplink signals from UE 120 may be received by antennas 1234, conditioned by demodulators 1232, processed by a MIMO detector 1236 if applicable, and further processed by a receive processor 1238 to obtain the data and control information transmitted by UE 120.

Controllers/processors 1240 and 1280 may direct operation at eNB 110 and UE 120, respectively. Processor 1240 and/or other processors and modules at eNB 110 may perform or direct process 600 in FIG. 6, process 1000 in FIG. 10, and/or other processes for the techniques described herein. Processor 1280 and/or other processors and modules at UE 120 may perform or direct process 800 in FIG. 8, process 1000 in FIG. 10, and/or other processes for the techniques described herein. Memories 1242 and 1282 may store data and program codes for eNB 110 and UE 120, respectively. A scheduler 1244 may schedule UEs for downlink and/or uplink transmission and may provide assignments of resources for the scheduled UEs.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of sending system information, comprising:
assigning at least one system information (SI) message with at least one SI window in a forward space after a reference time;
assigning at least one additional SI message with at least one additional SI window in a backward space prior to the reference time; and
sending each SI message within an SI window for the SI message.

2. The method of claim 1, further comprising:
determining the reference time based on a radio frame in which all SI messages repeat.

3. The method of claim 1, further comprising:
determining position of the SI window for each SI message based on an index of the SI message, a periodicity of the SI message, and an SI window length common for all SI messages.

4. The method of claim 1, further comprising:
determining a list of SI messages to send, wherein every other SI message in the list is assigned an SI window in the forward space, and wherein each remaining SI message in the list is assigned an SI window in the backward space.

5. The method of claim 1, further comprising:
determining position of the SI window for each SI message in accordance with equations:
$$SFN mod {T}_{n} ( {T}_{n} + FLOOR ( {x}_{n} / 10 ) ) mod {T}_{n} , \\ and$$
$${x}_{n} = - {1}^{( ( n - 1 ) mod 2 )} * CEIL ( \frac{n - 1}{2} ) * w ,$$
where n is an index of an SI message, Tₙ is a periodicity of SI message n, xₙ is an SI window offset for SI message n, w is an SI window length, SFN denotes system frame number, FLOOR denotes a floor operation, CEIL denotes a ceiling operation, and “mod” denotes a modulo operation.

6. The method of claim 1, further comprising:
sending a first set of system information blocks (SIBs) in the at least one SI message, the first set of SIBs being receivable by all user equipments (UEs); and
sending a second set of SIBs in the at least one additional SI message, the second set of SIBs being receivable by UEs capable of receiving SI messages in both the forward and backward spaces.

7. The method of claim 1, further comprising:
determining a list of SI messages to send, the list including the at least one SI message followed by the at least one additional SI message.

8. The method of claim 1, further comprising:
assigning the at least one SI message with a first index n for the forward space; and
assigning the at least one additional SI message with a second index m for the backward space.

9. The method of claim 1, further comprising:
determining position of the at least one SI window in the forward space based on a first set of equations; and
determining position of the at least one additional SI window in the backward space based on a second set of equations.

10. The method of claim 1, further comprising:
determining position of an SI window for each of the at least one SI message in accordance with equations:
SFN mod Tₙ=FLOOR(xₙ/10), and
xₙ=(n−1)*w,
where n is an index of an SI message among the at least one SI message, Tₙ is a periodicity of SI message n, xₙ, is an SI window offset for SI message n, w is an SI window length, SFN denotes system frame number, FLOOR denotes a floor operation, and “mod” denotes a modulo operation.

11. The method of claim 1, further comprising:
determining position of an SI window for each of the at least one additional SI message in accordance with equations:
SFN mod Tₘ=(Tₘ+FLOOR(xₘ/10))mod Tₘ, and
xₘ=−m*w,
where m is an index of an SI message among the at least one additional SI message, Tₘ is a periodicity of SI message m, xₘ is an SI window offset for SI message m, w is an SI window length, SFN denotes system frame number, FLOOR denotes a floor operation, and “mod” denotes a modulo operation.

12. An apparatus for wireless communication, comprising:
means for assigning at least one system information (SI) message with at least one SI window in a forward space after a reference time;
means for assigning at least one additional SI message with at least one additional SI window in a backward space prior to the reference time; and
means for sending each SI message within an SI window for the SI message.

13. The apparatus of claim 12, further comprising:
means for determining position of the SI window for each SI message based on an index of the SI message, a periodicity of the SI message, and an SI window length common for all SI messages.

14. The apparatus of claim 12, further comprising:
means for determining a list of SI messages to send, wherein every other SI message in the list is assigned an SI window in the forward space, and wherein each remaining SI message in the list is assigned an SI window in the backward space.

15. The apparatus of claim 12, further comprising:
means for sending a first set of system information blocks (SIBs) in the at least one SI message, the first set of SIBs being receivable by all user equipments (UEs); and
means for sending a second set of SIBs in the at least one additional SI message, the second set of SIBs being receivable by UEs capable of receiving SI messages in both the forward and backward spaces.

16. The apparatus of claim 12, further comprising:
means for determining position of the at least one SI window in the forward space based on a first set of equations; and
means for determining position of the at least one additional SI window in the backward space based on a second set of equations.

17. An apparatus for wireless communication, comprising:
at least one processor configured to assign at least one system information (SI) message with at least one SI window in a forward space after a reference time, to assign at least one additional SI message with at least one additional SI window in a backward space prior to the reference time, and to send each SI message within an SI window for the SI message.

18. The apparatus of claim 17, wherein the at least one processor is configured to determine position of the SI window for each SI message based on an index of the SI message, a periodicity of the SI message, and an SI window length common for all SI messages.

19. The apparatus of claim 17, wherein the at least one processor is configured to determine a list of SI messages to send, to assign every other SI message in the list with an SI window in the forward space, and to assign each remaining SI message in the list with an SI window in the backward space.

20. The apparatus of claim 17, wherein the at least one processor is configured to send a first set of system information blocks (SIBs) in the at least one SI message, the first set of SIBs being receivable by all user equipments (UEs), and to send a second set of SIBs in the at least one additional SI message, the second set of SIBs being receivable by UEs capable of receiving SI messages in both the forward and backward spaces.

21. The apparatus of claim 17, wherein the at least one processor is configured to determine position of the at least one SI window in the forward space based on a first set of equations, and to determine position of the at least one additional SI window in the backward space based on a second set of equations.

22. A computer program product, comprising:
a computer-readable medium comprising:
code for causing at least one computer to assign at least one system information (SI) message with at least one SI window in a forward space after a reference time,
code for causing the at least one computer to assign at least one additional SI message with at least one additional SI window in a backward space prior to the reference time, and
code for causing the at least one computer to send each SI message within an SI window for the SI message.

23. A method of receiving system information, comprising:
identifying at least one system information (SI) message assigned at least one SI window in a forward space following a reference time;
identifying at least one additional SI message assigned at least one additional SI window in a backward space prior to the reference time; and
receiving each SI message within an SI window for the SI message.

24. The method of claim 23, further comprising:
determining the reference time based on a radio frame in which all SI messages repeat.

25. The method of claim 23, further comprising:
determining position of the SI window for each SI message based on an index of the SI message, a periodicity of the SI message, and an SI window length common for all SI messages.

26. The method of claim 23, further comprising:
receiving a list of SI messages being sent, wherein every other SI message in the list is assigned an SI window in the forward space, and wherein each remaining SI message in the list is assigned an SI window in the backward space.

27. The method of claim 23, further comprising:
obtaining a first set of system information blocks (SIBs) from the at least one SI message, the first set of SIBs being intended for all user equipments (UEs); and
obtaining a second set of SIBs from the at least one additional SI message, the second set of SIBs being intended for UEs capable of receiving SI messages in both the forward and backward spaces.

28. The method of claim 23, further comprising:
receiving a list of SI messages being sent, the list including the at least one SI message followed by the at least one additional SI message.

29. The method of claim 23, further comprising:
determining position of the at least one SI window in the forward space based on a first set of equations; and
determining position of the at least one additional SI window in the backward space based on a second set of equations.

30. An apparatus for wireless communication, comprising:
means for identifying at least one system information (SI) message assigned at least one SI window in a forward space following a reference time;
means for identifying at least one additional SI message assigned at least one additional SI window in a backward space prior to the reference time; and
means for receiving each SI message within an SI window for the SI message.

31. The apparatus of claim 30, further comprising:
means for determining position of the SI window for each SI message based on an index of the SI message, a periodicity of the SI message, and an SI window length common for all SI messages.

32. The apparatus of claim 30, further comprising:
means for receiving a list of SI messages being sent, wherein every other SI message in the list is assigned an SI window in the forward space, and wherein each remaining SI message in the list is assigned an SI window in the backward space.

33. The apparatus of claim 30, further comprising:
means for obtaining a first set of system information blocks (SIBs) from the at least one SI message, the first set of SIBs being intended for all user equipments (UEs); and
means for obtaining a second set of SIBs from the at least one additional SI message, the second set of SIBs being intended for UEs capable of receiving SI messages in both the forward and backward spaces.

34. The apparatus of claim 30, further comprising:
means for determining position of the at least one SI window in the forward space based on a first set of equations; and
means for determining position of the at least one additional SI window in the backward space based on a second set of equations.

35. A method for wireless communication, comprising:
determining position of at least one system information (SI) window for at least one SI message based on a first set of equations; and
determining position of at least one additional SI window for at least one additional SI message based on a second set of equations.

36. The method of claim 35, further comprising:
sending each SI message within an SI window for the SI message.

37. The method of claim 35, further comprising:
receiving each SI message within an SI window for the SI message.

38. The method of claim 35, wherein the at least one SI window is located in a forward space following a reference time, and wherein the at least one additional SI window is located in a backward space prior to the reference time.

39. The method of claim 35, wherein the position of the SI window for each SI message is determined based on an index of the SI message, a periodicity of the SI message, and an SI window length common for all SI messages.
